(19) United States
(12) Patent Application Publication
(10) Pub. No.: US 2010/0055389 A1
(43) Pub. Date: Mar. 4, 2010

(54) Housing for Hand-Held Device with a Pair of Extruded Elements having Complementary Sections Removed and Corresponding Method

(75) Inventors: Joseph L. Allore, Mundelein, IL (US); Gary R. Weiss, Buffalo Grove, IL (US); Jason P. Wojack, Libertyville, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Libertyville, IL (US)

(21) Appl. No.: 12/269,601

(22) Filed: Nov. 12, 2008

Related U.S. Application Data
(60) Provisional application No. 61/093,330, filed on Aug. 31, 2008.

(51) Int. Cl. B32B 7/00; B29C 45/14

(52) U.S. Cl. 428/119; 264/242

(57) ABSTRACT

A housing for a hand-held electronic device and a corresponding method for forming the same are provided. The housing includes a first extruded element having a profile corresponding to a cross-section of the element, which is perpendicular to the direction of extrusion. The housing additionally includes a second extruded element, separate from the first extruded element, having a profile corresponding to a cross-section of the element, which is perpendicular to the direction of extrusion. At least complementary sections of the first extruded element and the second extruded element are respectively removed, such that when the first extruded element and the second extruded element are coupled together at least a portion of the originally extruded profiles, after the removal of the complementary sections of each of the first extruded element and the second extruded element, intersect without interfering.

### CROSS REFERENCE TO RELATED APPLICATIONS

This application claims priority from a U.S. Provisional Patent Application Ser. No. 61/093,330, filed Aug. 31, 2008.

### FIELD OF THE INVENTION

The present invention relates generally to a housing for a hand-held electronic device and a method for forming the same, and more particularly, to a two-part housing having a first extruded element and a second extruded element.

### BACKGROUND OF THE INVENTION

Hand-held electronic devices have often been made from two separately formed halves of a housing, a front half and a back half, which are coupled together with one or more fasteners, within which the electrical and mechanical components forming the device are placed. Often times, each of the front half and the back half are formed from plastic or other material using an injection molding process, which enables considerable freedom in incorporating diverse sizes and shapes, and which can be used to produce various functional and/or aesthetic effects. Generally, the desired sizes and shapes, and their corresponding arrangement are incorporated into the shape of a mold. The mold is then used to produce the parts.

More recently an increasing amount of housings are being seen, which are being made from materials other than plastics, such as various metals and metal alloys, where the use of metal materials have often been accompanied by still further manufacturing techniques for similarly producing separately formed halves, which are then coupled together. In the case of metals and metal alloys, various techniques including forging, and/or stamping and forming have often been used to produce components used in forming the housings.

The movement toward an increasing amounts of metal in the housings has been precipitated in part due to the decrease in the overall size of devices, while the size of displays, keypads, and other components have alternatively increased in size. This has resulted in less material (i.e. reduced device volume) being used in the formation of the housing, as well as the support structures within and/or forming part of the housing. Correspondingly, the material used to form the housing and/or the corresponding support structures have had to be formed from stronger materials able to withstand an ever increasing load per unit measure. This in turn has facilitated the increasing use of manufacturing processes, which are consistent with the more recently predominant materials being used.

With molded, forged and stamped parts, tooling used in economically producing large volumes of the parts tends to be very specific to a particular design, such that if changes need to be made to the design, often times corresponding changes need to made to the associated tooling. For example, if the parts which are being molded need to be changed, the mold from which the parts are produced would often similarly need to be changed. In some instances, an existing mold might be able to be modified to accommodate a particular change. In other instances, new molds might need to be produced.

Some manufacturing processes for housings for use in hand-held electronic devices have more recently involved the use of extruded materials. Extruded materials typically involve a manufacturing method where an amount of material is pushed or drawn through a die, thereby producing a formed element, which has a generally uniform profile at varying points along the length of the extruded element in the direction of extrusion. More specifically, the formed element generally has a uniform cross sectional shape which is defined by the size and the shape of the openings in the die through which material is pushed or drawn. In addition to using the die to define the outer cross sectional shape, hollow sections within the shape can similarly be formed, for example, by placing a pin or piercing mandrel inside the die. Traditionally, extrusions have been used in applications where an element having long, straight and generally uniform shapes are desired. For elements having significant variations along the length of the element, extrusions have typically been avoided.

Recent extruded elements used in the formation of a housing have included an extrusion having a one piece continuous outer profile, which is used to form each of the front, back and sides of the device. Such a construction can result in enhanced structural strength, in so far as the front, back and sides are formed as part of a one piece construction. A hollow section is formed in the extruded element having an opening at the beginning and end of the extrusion, often corresponding to a top and bottom, within which mechanical and electronic components can be placed. In some instances openings will be cut into the sidewall of the extruded element along the length of the same to provide more direct access to some of the internally placed and appropriately aligned mechanical and electronic components. After the components have been placed within the housing, the openings at the ends of the extrusion are generally capped.

In such an instance, the appearance of the housing is generally very uniform (i.e. generally does not vary) along the length of the extrusion. To date, such a construction has resulted in housings which have very limited amounts of variability along the length of the extrusion. While such a style can be very clean and uniform, sometimes such a style can be very plain. In some instances, it can be very difficult to deviate from such a style even when function and/or aesthetics would prefer such a deviation, which limits the type of housings that have historically been produced through such a manufacturing process.

Furthermore, the uniformity can sometimes interfere with the coupling of two extruded housing elements, including instances where it might be desirable for the extruded elements to form parts of multiple housing elements that move relative to one another. In at least one published reference, Jorgensen, US Published Patent Application No. 2007/0265028, an intermediate part has been used to facilitate an indirect coupling between two extruded elements, where the mechanism that enabled relative movement between the two housings was incorporated as part of the non-extruded intermediate part. In the specific instance, the intermediate part formed a hinge to which the extruded elements were attached. Such a design incorporates additional parts in support of the overall construction, and involves a separate non-extruded hinge element to be incorporated into the design to not only support the coupling, but to also support any relative movement between the two parts of the two-part housing.

The present inventors have recognized that it would be beneficial if multiple extruded elements could be developed, which would allow the multiple extruded elements to be more directly coupled together without including a non-extruded intermediate element. It would be further beneficial if the manner of more direct coupling would support relative movement of two extruded elements as part of a two part housing for a hand-held electronic device.

### SUMMARY OF THE INVENTION

The present invention provides a housing for a hand-held electronic device. The housing includes a first extruded element having a profile corresponding to a cross-section of the element, which is perpendicular to the direction of extrusion. The housing additionally includes a second extruded element, separate from the first extruded element, having a profile corresponding to a cross-section of the element, which is perpendicular to the direction of extrusion. At least complementary sections of the first extruded element and the second extruded element are respectively removed, such that when the first extruded element and the second extruded element are coupled together at least a portion of the originally extruded profiles, after the removal of the complementary sections of each of the first extruded element and the second extruded element, intersect without interfering.

In at least one embodiment, the portion of the originally extruded profiles of each of the first extruded element and the second extruded element which intersect without interfering, corresponds to at least part of a hinge.

In at least a further embodiment, the portion of the originally extruded profiles of each of the first extruded element and the second extruded element which intersect without interfering, corresponds to at least part of a slider mechanism enabling the first extruded element to move relative to the second extruded element in a direction along substantially parallel paths.

The present invention further provides a hand-held electronic device including a housing. The housing of the hand-held electronic device includes a first extruded element having a profile corresponding to a cross-section of the element, which is perpendicular to the direction of extrusion. The housing additionally includes a second extruded element, separate from the first extruded element, having a profile corresponding to a cross-section of the element, which is perpendicular to the direction of extrusion. At least complementary sections of the first extruded element and the second extruded element are respectively removed, such that when the first extruded element and the second extruded element are coupled together at least a portion of the originally extruded profiles, after the removal of the complementary sections of each of the first extruded element and the second extruded element, intersect without interfering.

The present invention still further provides a method for forming a housing for a hand-held electronic device. The method includes extruding a first element having a profile corresponding to a cross-section of the element, which is perpendicular to the direction of extrusion. A second element is then extruded, which has a profile corresponding to a cross-section of the element, which is perpendicular to the direction of extrusion. Each of the first extruded element and the second extruded element is then machined. The machining includes respectively removing at least complementary sections of the extruded first element and the extruded second element, such that when the extruded first element and the extruded second element are coupled together at least a portion of the originally extruded profiles, after the removal of the complementary sections of each of the extruded first element and the extruded second element, intersect without interfering.

### BRIEF DESCRIPTION OF THE DRAWINGS

FIG. 1 is a perspective view of an exemplary extruded element for use as part of a housing for a hand-held electronic device having a two part construction, in accordance with at least one aspect of the present invention;

FIG. 2 is a perspective view of a further exemplary extruded element for use with the exemplary extruded element illustrated in FIG. 1, as part of a housing for a hand-held electronic device having a two part construction, in accordance with at least one aspect of the present invention;

FIG. 3 is a partial front plan view of the exemplary extruded elements, illustrated in FIGS. 1 and 2, which highlights exemplary complimentary areas that can be removed in order to facilitate the two extruded elements being coupled together, where as part of the coupling, at least a portion of the originally extruded profiles can intersect without interfering;

FIG. 4 is a partial front plan view of the exemplary extruded elements, illustrated in FIGS. 1 and 2, which highlights alternative exemplary complimentary areas that can be removed in order to facilitate the two extruded elements being coupled together, where as part of the coupling, at least a portion of the originally extruded profiles can intersect without interfering;

FIG. 5 is a partial front plan view of the exemplary extruded elements, illustrated in FIGS. 1 and 2, which highlights further alternative exemplary complimentary areas that can be removed in order to facilitate the two extruded elements being coupled together, where as part of the coupling, at least a portion of the originally extruded profiles can intersect without interfering;

FIG. 6 is a perspective view of the extruded elements illustrated in FIGS. 1 and 2 coupled together after the complimentary areas, in accordance with the exemplary embodiment illustrated in FIG. 3, have been removed;

FIG. 7 is a partial side plan view of the exemplary coupling, illustrated in FIG. 6, of the extruded elements illustrated in FIGS. 1 and 2;

FIG. 8 is a further partial side plan view of the exemplary coupling, illustrated in FIG. 6, of the extruded elements illustrated in FIGS. 1 and 2, illustrating the rotation of one of the extruded elements relative to the other;

FIG. 9 is a partial front plan view of an alternative coupling of the extruded elements illustrated in FIGS. 1 and 2, after complementary sections have been removed, in accordance with the embodiment illustrated in FIG. 5;

FIG. 10 is a perspective view of an exemplary extruded element for use as part of a housing for a hand-held electronic device having a two part construction, in accordance with at least a further aspect of the present invention;

FIG. 11 is a top or bottom plan view of the exemplary extruded element, illustrated in FIG. 10;

FIG. 12 is a perspective view of a further exemplary extruded element for use with the exemplary extruded element illustrated in FIG. 10, as part of a housing for a hand-held electronic device having a two part construction, in accordance with at least a further aspect of the present invention;

FIG. 13 is a top or bottom plan view of the exemplary extruded element, illustrated in FIG. 12;

FIG. 14 is a perspective view of a still further exemplary extruded element for use with the exemplary extruded element illustrated in FIG. 10, as part of a housing for a hand-held electronic device having a two part construction, in accordance with at least a further aspect of the present invention;

FIG. 15 is a front plan view of the exemplary extruded element, illustrated in FIGS. 10 and 11, which highlights exemplary areas that can be removed in order to compliment areas removed in another exemplary extruded element, illustrated in FIG. 16, so as to facilitate the two extruded elements being coupled together, where as part of the coupling at least a portion of the originally extruded profiles can intersect without interfering;

FIG. 16 is a front plan view of the exemplary extruded element, illustrated in either FIGS. 12 and 13, or FIG. 14, which highlights exemplary areas that can be removed in order to compliment areas removed in another exemplary extruded element, illustrated in FIG. 15, so as to facilitate the two extruded elements being coupled together, where as part of the coupling at least a portion of the originally extruded profiles can intersect without interfering;

FIG. 17 is a partial perspective view of the exemplary extruded element, illustrated in FIG. 15, being coupled to the exemplary extruded element, illustrated in FIG. 16, where as part of the coupling at least a portion of the originally extruded profiles can intersect without interfering;

FIG. 18 is a perspective view of the extruded elements illustrated in FIGS. 10 and 12 coupled together after the complimentary areas, in accordance with the exemplary embodiments illustrated in FIGS. 15 and 16 have been removed;

FIG. 19 is a perspective view of the extruded elements illustrated in FIGS. 10 and 14 coupled together after the complimentary areas, in accordance with the exemplary embodiments illustrated in FIGS. 15 and 16, have been removed; and

FIG. 20 is a flow diagram of a method for forming a housing for a hand-held electronic device, in accordance with at least one embodiment of the present invention.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

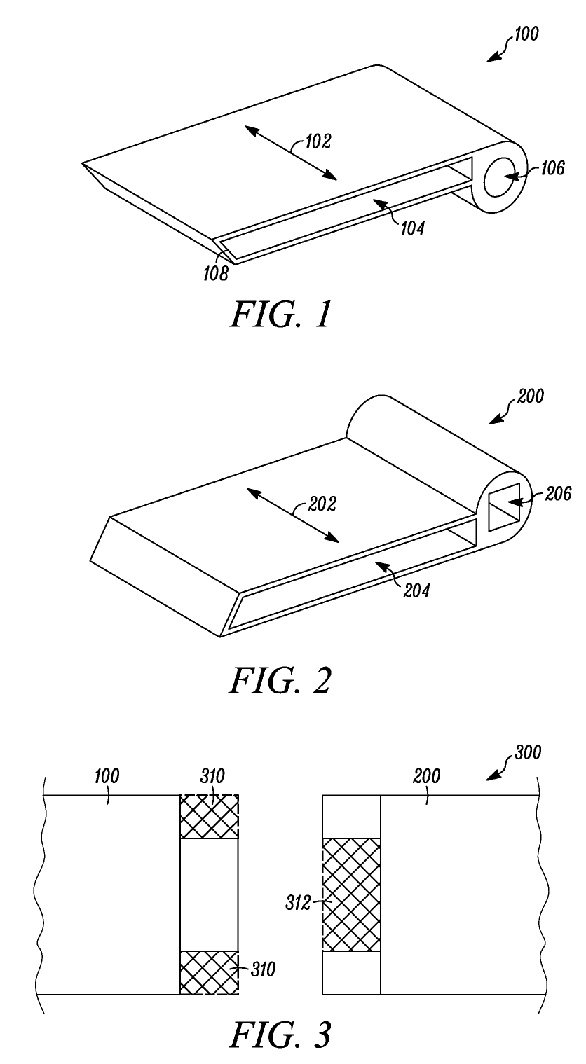

FIG. 1 illustrates a perspective view of an exemplary extruded element 100 for use as part of a housing for a hand-held electronic device having a two part construction, in accordance with at least one aspect of the present invention. In connection with the illustrated embodiment, an arrow 102 defines a direction of extrusion. The extruded element 100, similar to other extruded elements, has a profile, which is perpendicular to the direction of extrusion, that is generally uniform in the direction of extrusion, and is generally defined by the size and shape of an opening in a die through which the extruded material is pushed and/or drawn. In the illustrated embodiment, the profile is represented by the surface illustrated in the FIG. 1, which has a pair of openings 104 and 106, a nearly rectangular shaped opening 104 and a circular opening 106. The nearly rectangular opening 104, which is better described as a trapezoid, because of the slanted side 108 proximate the bottom of the extruded element, defines one end of an interior space that runs the length of the extruded element 100. Similarly, the circular opening 106, defines a cylindrically shaped interior space, that extends the length of the extruded element 100 in the direction of extrusion 102.

In at least one embodiment, the interior space corresponding to the nearly rectangular shaped opening 104 is adapted to receive electrical, mechanical and/or electromechanical components, which are intended to support the desired functionality of the device for which the extruded element 100 forms at least part of the housing. The interior space corresponding to the circular opening 106, in the illustrated embodiment, supports a portion of a hinge structure, where more specifically, the space is intended to receive a shaft or a pin about which the extruded element 100 can rotate.

FIG. 2 illustrates a perspective view of a further exemplary extruded element 200 similarly for use as part of a housing for a hand-held electronic device having a two part construction, in accordance with at least one aspect of the present invention. Relative to the extruded element 200 illustrated in FIG. 2, arrow 202 identifies a direction of extrusion. The profile of extruded element 200 similar to the extruded element illustrated in FIG. 1 includes a pair of openings 204 and 206, which includes a similar nearly rectangular (trapezoidal) opening 204, but alternatively includes a square opening 206, instead of the circular opening 106, in the proximate area intended to support hinge functionality. The square opening 206, alternatively enables a portion of the pin that might be received within the opening to have a square shape, which enables the pin to remain largely rotationally stable relative to extruded element 200. As a result, the rotation of a square shaped pin that is received within the interior space defined by the square opening will generally be aligned with a corresponding rotation of the extruded element. In at least some embodiments of the present invention, such a pin could be said to be largely rotationally fixed relative to the extruded element 200.

Similarly, the interior space corresponding to the nearly rectangular shaped opening 204 is adapted to receive electrical, mechanical and electromechanical components, which are intended to support the intended function of the device for which the extruded element 200 forms at least part of the housing. Where the extruded elements 100 and 200 are intended to form at least part of a housing for a hand-held electronic device, examples of the type of components that might be received within the corresponding interior space include displays, keypads, sensors, user actuatable switches, imaging assemblies, microphones, transducers, speakers, antennas, processor circuits, memory circuits, transmitter circuits, receiver circuits, power management circuits, power sources (i.e. batteries), jacks, connector ports, etc. In some instances, additional openings in the surface of the extruded element could be made into the otherwise continuous outer surface, separate from being formed as part of the extrusion process, to enable the user to interface with some of the included components. Examples of different types of hand-held devices for which the present invention might be suitable includes radio frequency (i.e. cellular) telephones, media (i.e. music) players, personal digital assistants, portable video gaming devices, cameras, and/or remote controls.

While each of the illustrated housings have sections which are intended to support a hinge type functionality, as presently configured the extruded element illustrated in FIG. 1 could not readily be coupled to the extruded element illustrated in FIG. 2, in a manner intended for providing the desired functionality, as the portion of the extruded element associated with the hinge in each of the extruded elements would interfere with one another, thereby precluding a coupling that would support the intended hinge-type functionality. Nevertheless, in accordance with the teachings of the present invention, complementary areas of each of the extruded elements 100 and 200 can be removed in order to facilitate the two extruded elements being coupled together, where as part of the coupling, at least a portion of the originally extruded profiles can then intersect without interfering.

In at least some embodiments, the removal of material occurs as a result of a machining process. In the context of the present invention, a machining process refers to a process subsequently applied after an extruding process that facilitates the further shaping of an extruded element through the removal of selective portions of the extruded element. In at least some embodiments, the machining process might take the form of cutting, drilling, grinding, stamping, punching and/or etching away of portions of the extruded element. One skilled in the art will appreciate that the above listed types of machining processes represent an exemplary list of various forms of machining, and that still further forms of machining can be used in conjunction with the extruded element for the removal of portions thereof without departing from the teachings of the present invention.

FIGS. 3-5 illustrate partial front plan views of the exemplary extruded elements, illustrated in FIGS. 1 and 2, which highlights exemplary complimentary areas that can be removed in order to facilitate the two extruded elements being coupled together, where as part of the coupling at least a portion of the originally extruded profiles can intersect without interfering. In FIG. 3, a partial plan view 300 is illustrated, which identifies the removal of the ends 310 from the hinge area of the extruded element 100 incorporating the portion of the profile having the circular opening 106, and the removal of the center section 312 from the hinge area of the extruded element 200 incorporating the portion of the profile having the square opening 206. The size and the shape of the areas being removed from each of the extruded elements 100 and 200 generally correspond to the size and shape of the material remaining in the other one of the extruded elements. In some instances, the size of the area being removed may be slightly larger than the size of the area remaining in the other one of the extruded elements, to enable the respective areas of the profiles intended to support a hinge-type function to more smoothly and/or with less friction intersect without interfering, and to be able to rotate with respect to one another relatively smoothly with less friction.

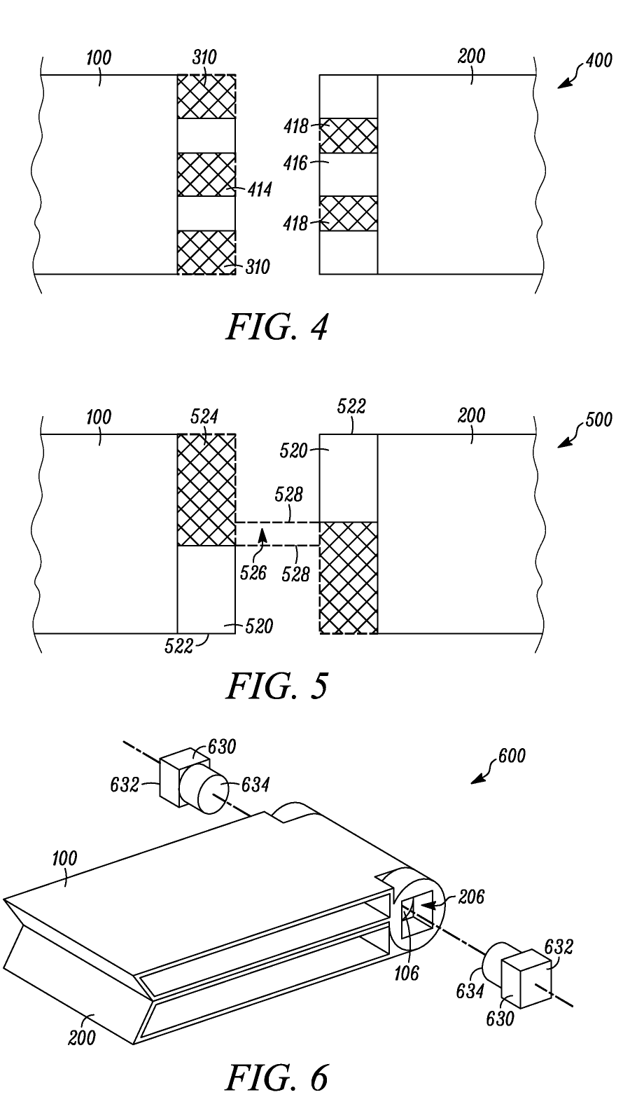

FIG. 4 illustrates a partial front plan view 400 of the exemplary extruded elements 100 and 200, illustrated in FIGS. 1 and 2, which highlights exemplary complimentary areas that can be removed in order to facilitate the two extruded elements being coupled together, in accordance with a further embodiment. In the further embodiment, in addition to the removal of the ends 310 from the extruded element 100, as illustrated in FIG. 3, a further center section 414 is removed. A corresponding center section 416 of the extruded element 200 is maintained, while the sections 418 immediately flanking the center section 416 on both sides are removed.

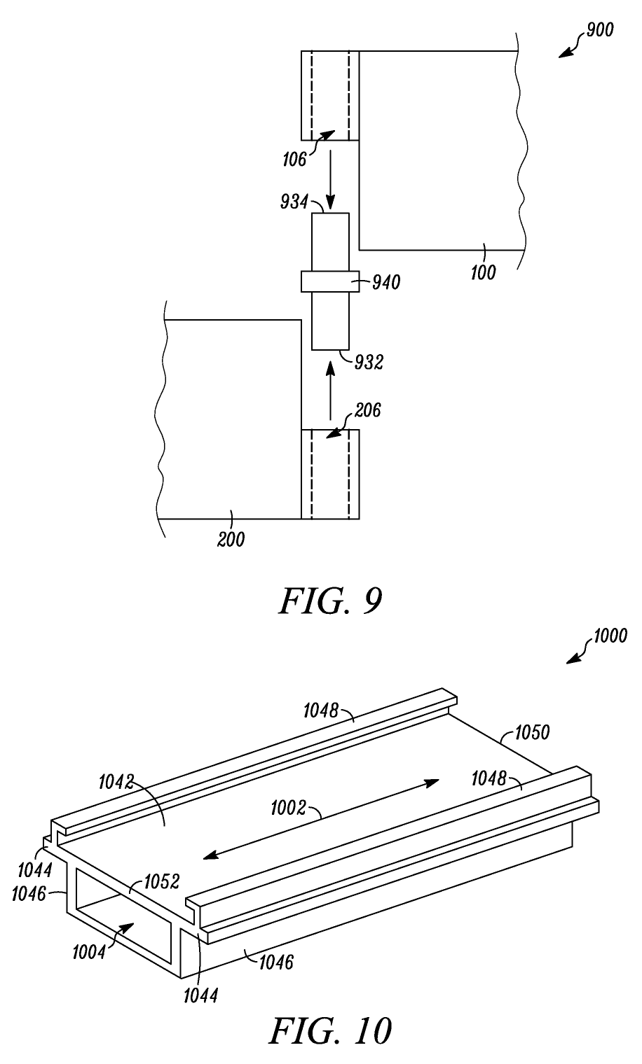

FIG. 5 illustrates a partial front plan view 500 of the exemplary extruded elements 100 and 200, illustrated in FIGS. 1 and 2, which highlights exemplary complimentary areas that can be removed in order to facilitate the two extruded elements being coupled together, in accordance with a still further embodiment. In the embodiment illustrated in FIG. 5, the portion 520 of the hinge area that is maintained for each of the extruded elements corresponds to the section of the hinge area beginning at alternative ones of the respective pair of ends 522 of the extrusion, and extending toward the center of the extruded element 100, 200 in the direction of extrusion 102, 202, while the complementary section 524 in the other one of the two extruded elements is removed. In the present instance, the area of removal extends beyond the complementary area, which results in an area 526 noted between dashed lines 528, where the material associated with hinge area is removed in both of the extruded elements 100 and 200. Such an area might facilitate a space in which another component might be placed, such as a portion of a shaft or a hinge pin. Such an exemplary embodiment is discussed below, in connection with FIG. 9.

By removing the complementary sections of each of the first extruded element 100 and the second extruded element 200, the first extruded element 100 and the second extruded element 200 can be coupled together, in a manner which enables their extruded profiles to intersect without interfering. In some instances, the coupling of the extruded elements may include an intermediary piece to which each of the extruded elements attach, and which might serve to assist in the movement of the two extruded elements, relative to one another. In at least some instances, such an intermediate element might include a shaft or a pin. FIG. 6 illustrates a perspective view 600 of the extruded elements 100 and 200 illustrated in FIGS. 1 and 2 coupled together after the complimentary areas 310 and 312, in accordance with the exemplary embodiment illustrated in FIG. 3, have been removed. In the illustrated embodiment as part of the coupling the two extruded elements together, a pair of pins 630 are installed, which when installed each extend between the opening 106 in the first extruded element 100 and the opening 206 in the second extruded element 200. In at least some instances when the first extruded element is brought into engagement with the second extruded element, the installation of the pin is aided, if the respective circular opening 106 and the square opening 206 are in substantially coaxial alignment and/or the openings are in registration with one another.

More specifically in the illustrated embodiment, the pins are sized and shaped, such that the pins have a circular end 632, which is adapted to be received within the circular opening 106, and a square end 634, which is adapted to be received within the square opening 206. The relative shaping of the circular opening 106 and the square opening 206, and correspondingly the circular end 632 and the square end 634 of the pin, enable the circular end 632 of the pin 630 to pass through both of the square opening 206 and the circular opening 106 without interference. The square end 634 of the pin 630 will generally pass an appropriately sized square opening, but will not similarly pass through the circular opening 106, as the corners of the square end 632 will not clear the opening 106. Furthermore, the shape of the square end 632 of the pin 630 and the corresponding square opening 206 will rotationally restrict the movement of the pin 630 relative to the second extruded element 200, while the circular end 634 of the pin 630 and the corresponding circular opening 106 will enable the first extruded element 100 to rotate more freely relative to the pin 630 and the second extruded element 200.

While the length of the circular end 634 of the pin 630 could be defined, such that the ends meet within the interior space of the first extruded element 100 defined by the circular opening 106, it is also possible that the pin will extend into the interior space a distance less than the distance needed for the two pins to meet. In such an instance, the portion of the interior space which is not occupied by the either of the two pins 630, could be used to place or route other components. For example the interior space that is unoccupied by either of the pins could be used to route a flex circuit and/or position portions of an imaging assembly (i.e. portions of a camera assembly).

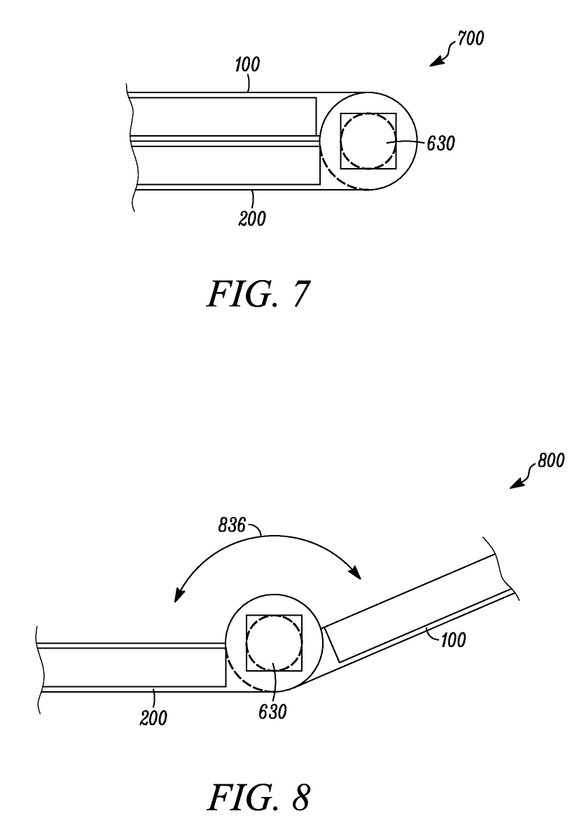

FIG. 7 illustrates a partial side plan view 700 of the exemplary coupling, illustrated in FIG. 6, of the extruded elements 100 and 200, illustrated in FIGS. 1 and 2. FIG. 8 illustrates a further partial side plan view 800 of the exemplary coupling, illustrated in FIGS. 6 and 7, of the extruded elements 100 and 200 illustrated in FIGS. 1 and 2, illustrating the rotation of one of the extruded elements 100 and 200, relative to the other one. As illustrated, the coupling provides a potential hinge type rotation of the two extruded elements relative to one another, in a direction highlighted by arrow 836, which could be used as the foundation for a housing of a hand-held electronic device having a two part housing, which is adapted to enable the relative rotation of the two housing parts of the device, such as a flip or clam-style device.

FIG. 9 illustrates a partial front plan view 900 of an alternative coupling of the extruded elements 100 and 200 illustrated in FIGS. 1 and 2, after complementary sections have been removed, in accordance with the embodiment illustrated in FIG. 5. While the particular embodiment illustrated in FIG. 6 included pins 630 that were inserted in a direction of entry originating from respective ones of the exposed external side surfaces, the shaft or pin 940 in the embodiment illustrated in FIG. 9 is positioned between the two extruded elements, and partially occupies the area 526, illustrated in FIG. 6, in which the corresponding material was removed from both of the extruded elements 100 and 200. The pin 940 includes a first end 934 having a circular cross-section, which is sized and shaped to fit within the circular opening 106. The pin 940 additionally includes a second end having a square-shaped cross-section, which is sized and shaped to fit within the square opening 932. As noted previously, the use of a square-shaped pin end 932 in a square-shaped opening 932 would largely limit the relative rotation between the pin 940 and the extruded element 200, while a relative rotation would be more readily supported between the pin 940 and the extruded element 100 by the use of a circular shaped pin end 934 and a corresponding circular opening 106. However in the illustrated embodiment, the relative rotation of the pin 940 with respect to only one of the extruded elements 100 is sufficient to support a relative rotation between each of the extruded elements 100 and 200, via pin 940. The difference in shape of a center section of the pin relative to the end of the pin where the center section has a larger diameter than the diameter of the ends of the pin would restrict the distance that the pin might extend into the coaxially aligned interior space formed via the circular opening 106 and the square-shaped opening of the respective extruded profiles.

While a circular and/or a square shaped opening are shown in the illustrated exemplary embodiments, one skilled in the art will readily recognize that alternative shapes are possible without departing from the teachings of the present invention. In some instances the same shape might be used for both extruded housings. In such an instance the shapes might be the same size, or the shapes might be of different sizes. Where the shapes are the same, but the sizes are different, the distance that a particular pin might extend into the coaxially aligned interior space would similarly be restricted, as a result of the differences in the cross-sectional area of the two ends of any particular matching pin. Furthermore, while the pin 940 in the illustrated embodiment is identified as a separate element, in at least some instances the pin 940 might be integrated and/or formed as part of one of the two extruded elements 100 or 200, as part of the removal of complementary sections, without departing from the teachings of the present invention.

In addition to the removal of complementary sections of a pair of extruded elements in support of a hinge mechanism for purposes of supporting the relative rotation of separate housings of a two part housing structure for a hand-held electronic device, the removal of complementary sections of a pair of extruded element could additionally be used to support a slider mechanism where the pair of extruded elements are intended to slide in a direction relative to one another along substantially parallel paths.

FIG. 10 illustrates a perspective view of an exemplary extruded element 1000 for use as part of a housing for a hand-held electronic device having a two part construction, in accordance with at least a further aspect of the present invention. In connection with the illustrated embodiment, an arrow 1002 defines a direction of extrusion. The extruded element 1000, similar to other extruded elements as well as other extruded elements that have been previously described herein, has a profile which is perpendicular to the direction of extrusion, that is generally uniform in the direction of extrusion, and is generally defined by the size and shape of an opening in a die through which the extruded material is pushed and/or drawn. In the illustrated embodiment, the profile is represented by the surface illustrated in FIG. 10, which has a substantially rectangular shaped opening 1004. The ends of the extruded element 1000 corresponding to the profile of the extrusion, respectively represent the top 1050 and the bottom 1052 of the extruded element 1000.

In addition to the rectangular shape surrounding the substantially rectangular shaped opening 1004, the front facing 1042 of the extruded element 1000 has a pair of arms 1044 which extend from each of the two sidewalls 1046 that further extend in a second direction the length of the extruded element in the direction of extrusion 1002. Extending from the front facing 1042 proximate respective ones of the pair of arms 1044 are a pair of inverted L-shaped protrusions 1048, similarly extending the length of the extruded element 1000.

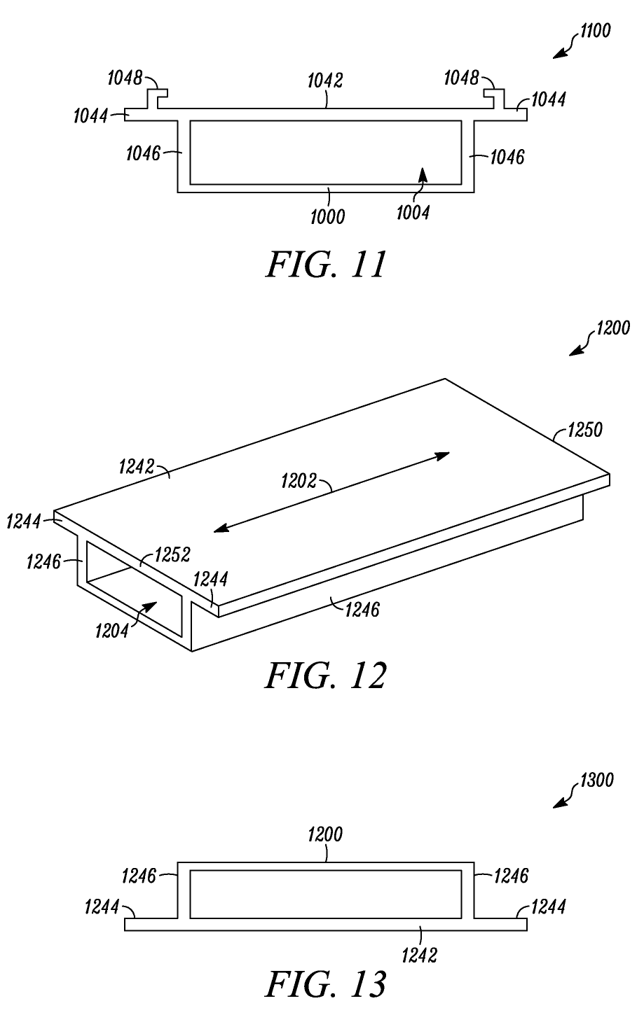

FIG. 11 illustrates a top or bottom plan view 1100 of the exemplary extruded element 1000, illustrated in FIG. 10.

FIG. 12 illustrates a perspective view of a further exemplary extruded element 1200 that could be used with the exemplary extruded element 1000 illustrated in FIG. 10, as part of a housing for a hand-held electronic device having a two part construction, in accordance with at least a further aspect of the present invention. The further exemplary extruded element is very similar to the extruded element illustrated in FIG. 10, with the exception that it does not have the inverted L-shaped protrusions 1048. More specifically, the extruded element has a profile having a rectangular shaped opening 1204, which defines an interior space that runs the length of the extruded element 1200 in the direction of extrusion 1202. Similarly, the front facing 1242 of the extruded element has a pair of arms 1244, where each arm extends from respective sides 1246 of the extruded element. The beginning and the end of the extruded element 1200 respectively correspond to a top 1250 and a bottom 1252 of the extruded element 1200.

FIG. 13 illustrates a top or bottom plan view 1300 of the exemplary extruded element 1200, illustrated in FIG. 12.

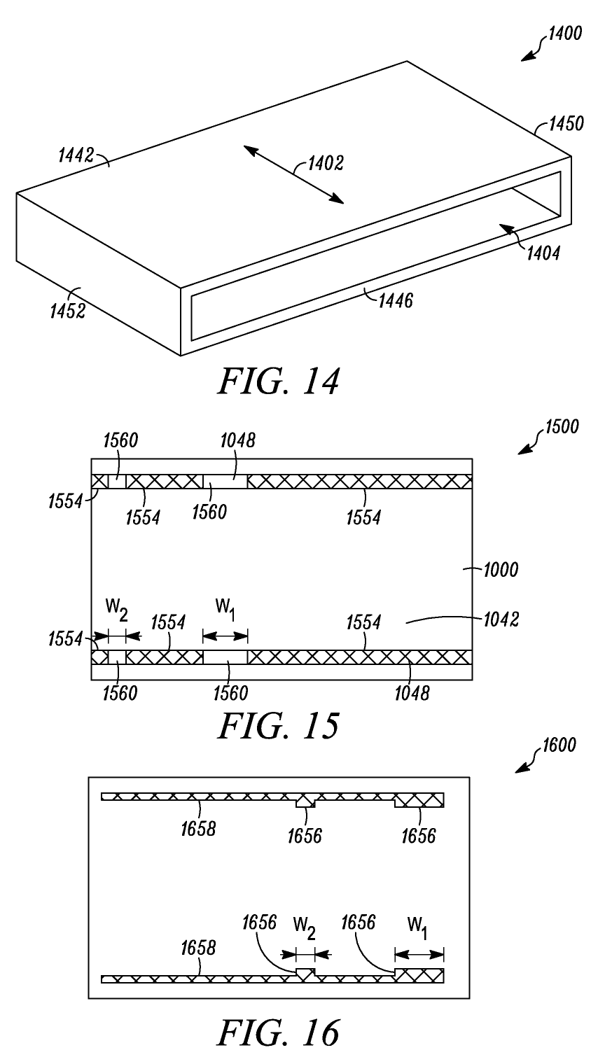

FIG. 14 illustrates a perspective view of a still further exemplary extruded element 1400 for use with the exemplary extruded element 1000 illustrated in FIG. 10, as part of a housing for a hand-held electronic device having a two part construction, in accordance with at least a further aspect of the present invention. The exemplary extruded element 1400 differs from the extruded element 1200 illustrated in FIG. 12 at least in the direction of extrusion 1402. As a result, the profile and corresponding substantially rectangular opening 1404 coincide with the sides 1446 of the extruded element 1400. The extruded element 1400 further differs from the extruded element 1200 illustrated in FIG. 12, in that front facing 1442 of the particular exemplary embodiment does not have arms extending from the side 1446, and/or top 1450 or bottom 1452 facings.

FIG. 15 illustrates a front plan view 1500 of the exemplary extruded element 1000, illustrated in FIGS. 10 and 11, which highlights exemplary areas 1554 that can be removed in order to compliment areas 1656 removed in another exemplary extruded element 1200 or 1400, illustrated in FIG. 16, so as to facilitate the two extruded elements being coupled together, where as part of the coupling at least a portion of the originally extruded profiles can intersect without interfering. More specifically, portions of the inverted L-shaped protrusions 1048 are removed, in order that a hook or pin-like protrusion 1560 with a hooked end remains at desired locations along the length of each side of extruded element 1000, at different points along the length of the element in the direction of extrusion. The hooked end corresponds to a horizontal portion of the inverted L-shaped protrusions 1048 or the portion of the inverted L-shaped protrusions 1048 that runs substantially parallel to the front facing 1042.

FIG. 16 illustrates a front plan view 1600 of the exemplary extruded element 1200 or 1400, illustrated in either FIGS. 12 and 13, or FIG. 14, which highlights exemplary areas 1656 that can be removed in order to compliment areas 1554 that can be removed in the exemplary extruded element 1000, illustrated in FIG. 15, so as to facilitate the two extruded elements being coupled together without interference. It is noted that the front plan view 1600 is consistent with each of the extruded element 1200 illustrated in FIG. 12, and the extruded element 1400 illustrated in FIG. 14.

In the illustrated embodiment, areas 1656 are removed from the front facing 1242 or 1442, so as to enable the corresponding hook or pin-like protrusion 1560 with a hooked end to line up with and extend through the removed areas 1656. Additional areas supporting a rail or slot 1658 are similarly removed. The rail or slot 1658 enables a vertical portion of the inverted L-shaped protrusions 1048 or the portion of the inverted L-shaped protrusions 1048 that extends substantially perpendicular to the front facing 1042 to move transversely along the length of the rail or slot 1658, which in turn allows the extruded element 1000 to move relative to extruded element 1200 or 1400 along substantially parallel paths. When the hook or pin-like protrusion 1560 with a hooked end of extruded element 1000 are aligned with the removed areas 1656, the profile of extruded element 1000 can intersect without interfering with the profile of extruded element 1200 or 1400.

In at least some instances, the width of the hook or pin-like protrusion 1560 with a hooked end in a given row can decrease in width in the direction of the anticipated relative movement along the substantially parallel paths of the two extruded elements. Similarly, the removed areas 1656 are keyed to match the decreasing width. This allows a wider hook or pin-like protrusion 1560 with a hooked end to interact with a narrower removed area 1656 without the protrusion 1560 passing through the removed area, except for at the one point along the point of travel that supports the initial coupling of the two extruded elements. A mechanical stop can then be added after the coupling of the two extruded elements and the extruded elements are allowed to slide away from the initial coupling position, in order to limit the movement back to the initial coupling position that would readily enable a decoupling.

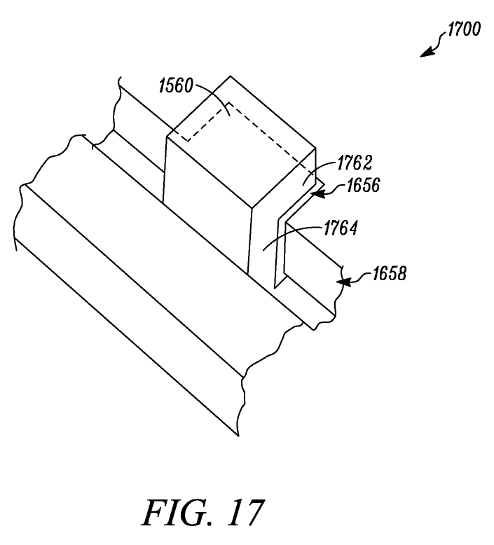

FIG. 17 illustrates a partial perspective view 1700 of the exemplary extruded element 1000, illustrated in FIG. 15, being coupled to the exemplary extruded element 1200 or 1400, illustrated in FIG. 16, where as part of the coupling at least a portion of the originally extruded profiles can intersect without interfering. More specifically, the hook or pin-like protrusion 1560 with a hooked end can extend through the removed areas 1656, where sufficient clearance is provided by the removal of areas 1656 to enable the portion of the inverted L-shaped protrusions 1048 that runs substantially parallel to the front facing 1042 to extend through, where the height of the vertical portion 1764 or the portion of the inverted L-shaped protrusions 1560 that runs substantially perpendicular to the front facing 1042 enables the horizontal portion 1762 to extend fully through the thickness of the front facing 1242 or 1442 of the extruded element 1200 or 1400.

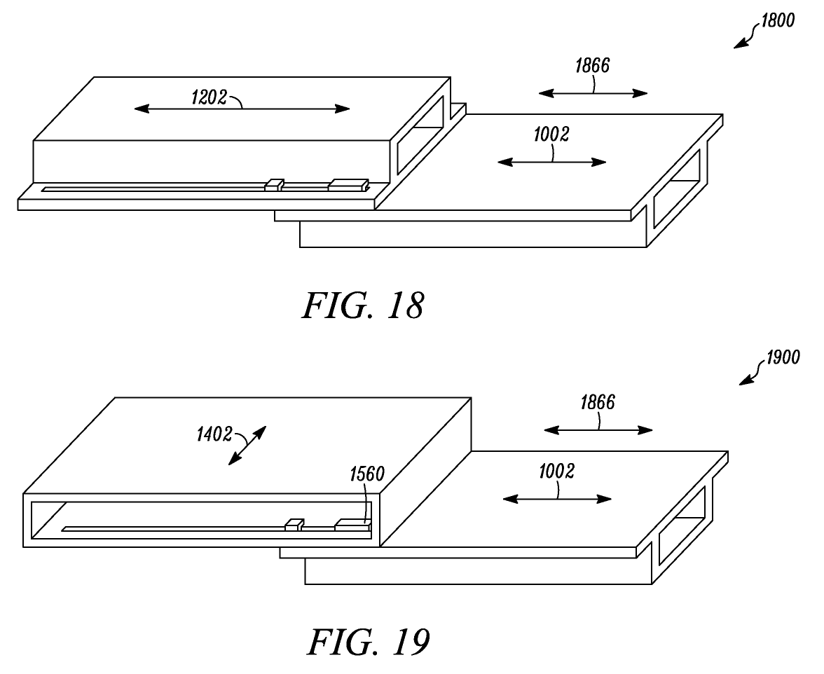

FIG. 18 illustrates a perspective view 1800 of the extruded elements 1000 and 1200 illustrated in FIGS. 10 and 12 coupled together after the complimentary areas 1554 and 1656, in accordance with the exemplary embodiments illustrated in FIGS. 15 and 16, have been removed. In the embodiment illustrated in FIG. 18, the two extruded elements 1000 and 1200 are intended to be coupled together, such that the directions of extrusion 1002 and 1202 of the coupled elements are substantially parallel.

Alternatively, FIG. 19 illustrates a perspective view 1900 of the extruded elements 1000 and 1400 illustrated in FIGS. 10 and 14 coupled together after the complimentary areas 1554 and 1656, in accordance with the exemplary embodiments illustrated in FIGS. 15 and 16, have been removed. In the embodiment illustrated in FIG. 19, the two extruded elements 1000 and 1400 are intended to be coupled together, such that the directions of extrusion 1002 and 1402 of the coupled elements are substantially perpendicular.

In each of FIGS. 18 and 19, the corresponding coupling support an intersection of the profiles of the extruded elements without interference, as well as a relative movement of the two extruded elements. Such a relative movement supports a two part housing arranged to provide a slider type arrangement, where one of the housing parts associated with a first one of the extruded elements is adapted to move in a direction 1866 relative to a second one of the housing parts associated with a second one of the extruded elements along substantially parallel paths.

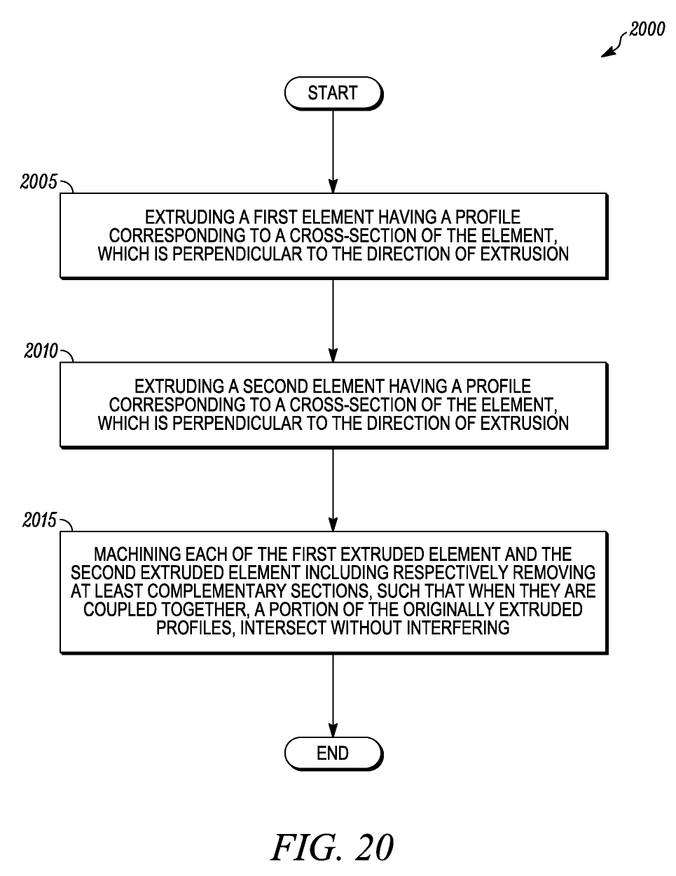

FIG. 20 illustrates a flow diagram of a method 2000 for forming a housing for a hand-held electronic device, in accordance with at least one embodiment of the present invention. The method includes extruding 2005 a first element having a profile corresponding to a cross-section of the element, which is perpendicular to the direction of extrusion, and extruding 2010 a second element having a profile corresponding to a cross-section of the element, which is perpendicular to the direction of extrusion. Each of the first extruded element and the second extruded element are then machined 2015 including respectively removing at least complementary sections of the extruded first element and the extruded second element, such that when the extruded first element and the extruded second element are coupled together at least a portion of the originally extruded profiles, after the removal of the complementary sections of each of the extruded first element and the extruded second element, intersect without interfering.

One skilled in the art will recognize that the complementary sections removed in any of the above described instances can take many different forms, without departing from the teachings of the present invention. For example, the removal of complementary sections in the case of the embodiments illustrated in FIGS. 10-19 might result in a different number of hooks or pin-like protrusions with a hooked end. Furthermore, the size and shape of the features of the extruded elements prior to machining could similarly be modified without departing from the teachings of the present invention.

While the preferred embodiments of the invention have been illustrated and described, it is to be understood that the invention is not so limited. Numerous further modifications, changes, variations, substitutions and equivalents will occur to those skilled in the art without departing from the spirit and scope of the present invention as defined by the appended claims.

What is claimed is:

1. A housing for a hand-held electronic device comprising:
a first extruded element having a profile corresponding to a cross-section of the element, which is perpendicular to the direction of extrusion; and
a second extruded element, separate from the first extruded element, the second extruded element having a profile corresponding to a cross-section of the element, which is perpendicular to the direction of extrusion; and
wherein at least complementary sections of the first extruded element and the second extruded element are respectively removed, such that when the first extruded element and the second extruded element are coupled together at least a portion of the originally extruded profiles, after the removal of the complementary sections of each of the first extruded element and the second extruded element, intersect without interfering.

2. A housing for a hand-held electronic device in accordance with claim 1, wherein the respective removal of complementary sections of the first extruded element and the second extruded element includes the respective removal of material from the first extruded element and the second extruded element of sections at different points along the length of the extrusion measured from a common reference point in the direction of extrusion in the portion of the original extruded profiles corresponding to the area of intersection, when the first extruded element is coupled to the second extruded element.

3. A housing for a hand-held electronic device in accordance with claim 2, wherein along the length of the extrusion in the area of intersection, material remaining at a particular point along the length of the extrusion in one of the first extruded element and the second extruded element corresponds to material having been removed at a complementary point along the length of the extrusion in the other one of the first extruded element and the second extruded element, relative to the area of intersection where the first extruded element and the second extruded element would intersect when coupled together.

4. A housing for a hand-held electronic device in accordance with claim 1, wherein the first extruded element and the second extruded element form a two part housing, wherein when coupled together each of the first extruded element and the second extruded element move relative to one another, and wherein portions of the originally extruded profiles of the first extruded element and the second extruded element intersect without interfering during the intended relative movement.

5. A housing for a hand-held electronic device in accordance with claim 4, wherein the portion of the originally extruded profiles of each of the first extruded element and the second extruded element which intersect without interfering, corresponds to at least part of a hinge.

6. A housing for a hand-held electronic device in accordance with claim 5, wherein about said hinge, the first extruded element and the second extruded element are rotatable relative to one another, while the first extruded element and the second extruded element are coupled together.

7. A housing for a hand-held electronic device in accordance with claim 5, wherein the first extruded element and the second extruded element, each, include an opening, which extends in the direction of extrusion through the portion of the extrusion from which complementary sections are removed, and wherein when the first extruded element is coupled to the second extruded element the respective openings are in coaxial registration.

8. A housing for a hand-held electronic device in accordance with claim 7, further comprising one or more shafts, which extend at least partially into the opening of each of the first extruded element and the second extruded element.

9. A housing for a hand-held electronic device in accordance with claim 8, wherein the first extruded element rotates relative to the second extruded element about said one or more shafts.

10. A housing for a hand-held electronic device in accordance with claim 4, wherein the portion of the originally extruded profiles of each of the first extruded element and the second extruded element which intersect without interfering, corresponds to at least part of a slider mechanism enabling the first extruded element to move relative to the second extruded element in a direction along substantially parallel paths.

11. A housing for a hand-held electronic device in accordance with claim 10, wherein the slider mechanism includes a rail or slot associated with one of the first extruded element and the second extruded element, which defines a path along which an other one of the first extruded element and the second extruded element travels.

12. A housing for a hand-held electronic device in accordance with claim 11, wherein the other one of the first extruded element and the second extruded element includes a pin or hook for engaging the rail or slot.

13. A housing for a hand-held electronic device in accordance with claim 12, wherein the slider mechanism includes a slot associated with said one of the first extruded element and the second extruded element, and a pin having a hooked end associated with the other one of the first extruded element and the second extruded element.

14. A housing for a hand-held electronic device in accordance with claim 13, wherein the complementary removal of material from said one of the first extruded element and the second extruded element forms one or more clearance openings associated with the slot, each clearance opening for receiving a hooked end of a cooresponding one of one or more pins formed from the complementary removal of material from said other one of the first extruded element and the second extruded element.

15. A housing for a hand-held electronic device in accordance with claim 14, wherein the one or more clearance openings include multiple clearance openings, and the one or more pins include multiple pins, each pin corresponding to one of the multiple clearance openings, wherein the multiple clearance openings have varying widths, which are sized to match the width of a the hooked end of the corresponding one of the one or more pins, wherein pins having a hooked end with a width greater than the size of the width of the one or more clearance openings can interact without the hooked end of the pin passing through the clearance opening.

16. A housing for a hand-held electronic device in accordance with claim 15, the width of both the clearance openings and the hooked ends increase sequentially in the direction of anticipated travel along the length of the path defined by the rail or slot; wherein the first extruded element is coupled to the second extruded element proximate one end of the path, and the hooked ends of the pins interact with clearance openings having sequentially decreasing widths as the first extruded element moves relative to the second extruded element toward the other end of the path.

17. A housing for a hand-held electronic device in accordance with claim 11, wherein the rail or slot extends along the length of the associated one of the first extruded element and the second extruded element substantially parallel to the direction of extrusion.

18. A housing for a hand-held electronic device in accordance with claim 11, wherein the rail or slot extends along the length of the associated one of the first extruded element and the second extruded element substantially perpendicular to the direction of extrusion.

19. A housing for a hand-held electronic device in accordance with claim 10, wherein the direction of extrusion of one of the first extruded element and the second extruded element is substantially parallel to the direction of relative movement, and the direction of extrusion of the other one of the first extruded element and the second extruded element is substantially perpendicular to the direction of relative movement.

20. A hand-held electronic device including a housing comprising:
a first extruded element having a profile corresponding to a cross-section of the element, which is perpendicular to the direction of extrusion; and
a second extruded element, separate from the first extruded element, the second extruded element having a profile corresponding to a cross-section of the element, which is perpendicular to the direction of extrusion; and
wherein at least complementary sections of the first extruded element and the second extruded element are respectively removed, such that when the first extruded element and the second extruded element are coupled together at least a portion of the originally extruded profiles, after the removal of the complementary sections of each of the first extruded element and the second extruded element, intersect without interfering.

21. A method for forming a housing for a hand-held electronic device comprising:
extruding a first element having a profile corresponding to a cross-section of the element, which is perpendicular to the direction of extrusion;
extruding a second element having a profile corresponding to a cross-section of the element, which is perpendicular to the direction of extrusion; and
machining each of the first extruded element and the second extruded element including respectively removing at least complementary sections of the extruded first element and the extruded second element, such that when the extruded first element and the extruded second element are coupled together at least a portion of the originally extruded profiles, after the removal of the complementary sections of each of the extruded first element and the extruded second element, intersect without interfering.

22. A method for forming a housing for a hand-held electronic device in accordance with claim 21, further comprising coupling the extruded first element to the extruded second element, wherein when coupled together the extruded first element and the extruded second element are adapted to rotate relative to one another while the originally extruded profiles intersect without interfering.
